(19) United States
(12) Patent Application Publication
(10) Pub. No.: US 2024/0319374 A1
(43) Pub. Date: Sep. 26, 2024

(54) DE-ALIASING INDIRECT TIME-OF-FLIGHT MEASUREMENTS

(71) Applicant: QUALCOMM Incorporated, San Diego, CA (US)

(72) Inventors: Xiaoliang BAI, San Diego, CA (US); Yingyong QI, San Diego, CA (US); Li HONG, San Diego, CA (US); Ning BI, San Diego, CA (US); Xiaoyun JIANG, San Diego, CA (US)

(21) Appl. No.: 18/187,616

(22) Filed: Mar. 21, 2023

(51) Int. Cl. G01S 17/894; G01B 11/22; G01S 7/4915; G06T 7/50

(52) U.S. Cl. CPC G01S 17/894; G01B 11/22; G01S 7/4915; G06T 7/50; G06T 2207/20021; G06T 2207/20084

(57) ABSTRACT

Systems and techniques are described herein for determining depth information. For instance, a method for determining depth information is provided. The method may include transmitting electromagnetic (EM) radiation toward a plurality of points in an environment; comparing a phase of the transmitted EM radiation with a phase of received EM radiation to determine a respective time-of-flight estimate of the EM radiation between transmission and reception for each point of the plurality of points in the environment; determining first depth information based on the respective time-of-flight estimates determined for each point of the plurality of points in the environment; obtaining second depth information based on an image of the environment; comparing the first depth information with the second depth information to determine an inconsistency between the first depth information and the second depth information; and adjusting a depth of the first depth information based on the inconsistency.

### TECHNICAL FIELD

The present disclosure generally relates to processing time-of-flight measurements. For example, aspects of the present disclosure include systems and techniques for de-aliasing indirect time-of-flight measurements (e.g., to remove the effects of multicycle aliasing from the indirect time-of-flight measurements).

### BACKGROUND

An indirect Time-of-Flight (iToF) depth camera may measure a phase difference between an emitted light pulse and the light pulse as received by the iToF depth camera after the light pulse has been reflected by an object in the environment. The iToF depth camera may relate the phase difference to a time-of-flight of the light pulse between emission and reception, based on the speed of light and the frequency of the light pulse. The iToF depth camera may, based on the time-of-flight and the speed of light, calculate a distance between the iToF depth camera and the object in the environment. In the present disclosure, the terms “light,” “light pulse,” and like terms may refer to electromagnetic radiation of any frequency, whether in the spectrum of visible light or not. In the present disclosure, the term “object,” when referring to an environment, may include discrete objects, points on objects, and points in the environment including the ground and/or walls etc. In the present disclosure, the term “depth” may refer to a distance between a sensor (e.g., of an iToF depth camera) and an object.

IToF phase-difference measurements may be cyclic. For example, phase measurements may repeat every integer number of half wavelengths of the light pulse that an object is from an iToF depth camera. For example, an iToF depth camera may emit a light pulse having a frequency of 20 megahertz (MHz) and a wavelength of about 15 meters. The iToF depth camera may measure a phase difference based on a first reflection from a first object that is three meters from the iToF depth camera. The iToF depth camera may measure the same phase difference based on a second reflection from a second object that is 10.5 meters (3 meters plus a half wavelength) from the iToF depth camera. Thus, iToF depth measurements may be subject to multicycle aliasing. In the present disclosure, the term “multicycle aliasing” may refer to the inability of an iToF depth camera to distinguish between two or more depths based on phase-difference measurements. Multicycle aliasing limits the accuracy of iToF depth cameras.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining depth information. According to at least one example, a method is provided for determining depth information. The method includes: transmitting electromagnetic (EM) radiation toward a plurality of points in an environment; comparing a phase of the transmitted EM radiation with a phase of received EM radiation to determine a respective time-of-flight estimate of the EM radiation between transmission and reception for each point of the plurality of points in the environment; determining first depth information based on the respective time-of-flight estimates determined for each point of the plurality of points in the environment; obtaining second depth information based on an image of the environment; comparing the first depth information with the second depth information to determine an inconsistency between the first depth information and the second depth information; and adjusting a depth of the first depth information based on the inconsistency

In another example, an apparatus for determining depth information is provided that includes at least one memory and at least one processor (e.g., configured in circuitry) coupled to the at least one memory. The at least one processor configured to: cause at least one transmitter to transmit electromagnetic (EM) radiation toward a plurality of points in an environment; compare a phase of the transmitted EM radiation with a phase of received EM radiation to determine a respective time-of-flight estimate of the EM radiation between transmission and reception for each point of the plurality of points in the environment; determine first depth information based on the respective time-of-flight estimates determined for each point of the plurality of points in the environment; obtain second depth information based on an image of the environment; compare the first depth information with the second depth information to determine an inconsistency between the first depth information and the second depth information; and adjust a depth of the first depth information based on the inconsistency. In some cases, the apparatus includes the at least one transmitter configured to transmit the EM radiation toward a plurality of points in an environment.

In another example, a non-transitory computer-readable medium is provided that has stored thereon instructions that, when executed by one or more processors, cause the one or more processors to: instruct at least one transmitter to transmit electromagnetic (EM) radiation toward a plurality of points in an environment; compare a phase of the transmitted EM radiation with a phase of received EM radiation to determine a respective time-of-flight estimate of the EM radiation between transmission and reception for each point of the plurality of points in the environment; determine first depth information based on the respective time-of-flight estimates determined for each point of the plurality of points in the environment; obtain second depth information based on an image of the environment; compare the first depth information with the second depth information to determine an inconsistency between the first depth information and the second depth information; and adjust a depth of the first depth information based on the inconsistency.

In another example, an apparatus for determining depth information is provided. The apparatus includes: means for transmitting electromagnetic (EM) radiation toward a plurality of points in an environment; means for comparing a phase of the transmitted EM radiation with a phase of received EM radiation to determine a respective time-of-flight estimate of the EM radiation between transmission and reception for each point of the plurality of points in the environment; means for determining first depth information based on the respective time-of-flight estimates determined for each point of the plurality of points in the environment; means for obtaining second depth information based on an image of the environment; means for comparing the first depth information with the second depth information to determine an inconsistency between the first depth information and the second depth information; and means for adjusting a depth of the first depth information based on the inconsistency.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The application file contains at least one drawing executed in color. Copies of this patent application publication with color drawing(s) will be provided by the Office upon request and payment of the necessary fee.

Illustrative examples of the present application are described in detail below with reference to the following figures:

FIG. 1 is a block diagram illustrating a system for de-aliasing indirect time-of-flight (iToF) depth measurements, according to various aspects of the present disclosure;

FIG. 2 is a block diagram illustrating another system for de-aliasing iToF depth measurements, according to various aspects of the present disclosure;

FIG. 3 includes a visual representation of example image-based depth information, an example image including depth partitions, and a visual representation of example iToF-based depth information partitioned by depth partitions 310, according to various aspects of the present disclosure;

FIG. 4 includes three representations of three respective example depth partitions and a representation of a merged depth partition, according to various aspects of the present disclosure;

FIG. 5 is a block diagram illustrating a system for de-aliasing iToF depth measurements, according to various aspects of the present disclosure;

FIG. 6 is a flow diagram illustrating a process for de-aliasing iToF depth measurements, in accordance with aspects of the present disclosure;

FIG. 7 illustrates an example of a deep learning neural network that can be used to implement a perception module and/or one or more validation modules, according to some aspects of the disclosed technology;

FIG. 8 is an illustrative example of a convolutional neural network (CNN), according to various aspects of the present disclosure; and

FIG. 9 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

An indirect time-of-flight (iToF) depth camera may emit one more light pulses into an environment and determine depth information relative to the environment (e.g., iToF-based depth information). For example, the iToF depth camera may emit one or more light pulses and receive and focus reflected light pulses onto an array of sensors. Using the array of sensors, the iToF depth camera may determine depths for each of a number of points within a field of view of the iToF depth camera. The number of depths may be depth information representative of depths of objects in the environment.

As described above, multicycle aliasing limits the accuracy of indirect time-of-flight (iToF) depth measurements because objects at integer numbers of half wavelengths away from an iToF depth camera can reflect light pulses that have the same phase difference when compared with the emitted light pulse. Thus, an iToF depth camera may be unable to distinguish depths based on phase difference alone. In other words, iToF depth cameras may suffer from multicycle aliasing.

One existing technique to mitigate multicycle aliasing in iToF depth measurements is to use the signal strengths of reflections as a factor when determining depths. The existing technique relies on the assumption that reflections from objects that are closer to a sensor will be stronger than reflections from objects that are farther away from the sensor. However, there are many factors that affect signal strength of reflections. For example, any or all of a material reflection property of an object (e.g., metal vs. cloth), a color of the object (e.g., dark vs. bright), and/or an orientation of the object (e.g., a degree of correlation between direction from which light pulses were received at the object and the surface normal of the object) may affect signal strength of a reflection from the object.

Systems, apparatuses, methods (also referred to as processes), and computer-readable media (collectively referred to herein as “systems and techniques”) are described herein for de-aliasing iToF depth measurements. In the present disclosure, the term “de-aliasing,” as referring to depth measurements, may refer to determining a depth where multiple depths were possible based on multicycle aliasing of phase-difference measurements. The systems and techniques described herein may obtain first depth information (e.g., iToF-based depth information) of an environment. The systems and techniques may obtain second depth information (e.g., image-based depth information, determined using an image-based depth-estimation technique, such as, a monocular-depth-estimation technique or a stereoscopic-depth-estimation technique). The systems and techniques may de-alias the first depth information using the second depth information.

IToF depth cameras may be more expensive and/or larger than images sensors, at least in part because iToF depth cameras are active sensors (emitting light pulses) whereas image sensors are passive (receiving light without necessarily emitting). IToF-based depth information may be more accurate than image-based depth information, for example, monocular-image-based depth information may suffer from scale ambiguity and stereo-image-based depth information may suffer from holes, spikes, or other imperfections. Further iToF-based depth information may include absolute distances (e.g., based on the time-of-flight of light) whereas image-based depth information may not include absolute distances but may instead include relative distances or approximations based on image blur etc. Nevertheless, image-based depth information may provide valuable insights into the sequence of objects (e.g., from close to camera to far away from the camera).

The systems and techniques described herein may compare ordered image-based depth information with ordered iToF-based depth information. Based on the comparison, systems and techniques may determine which depths (or groups of depths) in the iToF-based depth information are inconsistent with corresponding depths in the image-based depth information. Inconsistencies may indicate errors in the iToF-based depth information resulting from multicycle aliasing. For example, a wall may appear far away from a camera based on image-based depth information. IToF-based depth information may indicate that the same wall is close to an iToF depth camera (that is collocated with the camera) because multicycle aliasing may affect the iToF depth measurements. By comparing the order of depths in the iToF-based depth information with the order of depths in the image-based depth information, systems and techniques may determine errors in the iToF-based depth information.

The systems and techniques can utilize the order of depths of objects in image-based depth information instead of depths in the image-based depth information. Given that many image-based depth-estimation techniques have limitations such as temporal stability issue, scale ambiguity issue, etc. the systems and techniques usage of image-based depth information may be more general and more robust.

When the systems and techniques determine inconsistencies between the order of depths of the iToF-based depth information and the order of depths of the image-based depth information, systems and techniques can adjust the iToF-based depth information by adding or subtracting integer numbers of half wavelengths of light pulses to the depths. The systems and techniques may add integer numbers of half wavelengths because, based on multicycle aliasing, the iToF depth measurements may be off by integer numbers of half wavelengths. After adjusting the iToF-based depth information, the systems and techniques may reorder the depths of the iToF-based depth information and compare the reordered depths with the ordered depths of the image-based depth information and make additional adjustments based on additional inconsistencies.

The systems and techniques provide a robust, power-efficient solution to solve multicycle aliasing issues in iToF depth measurements. The systems and techniques combine the benefits of iToF depth measurements (e.g., measured absolute depth, low power, etc.) with the benefits of image-based depth-estimation techniques (low cost) to generate a more accurate, coherent depth map than is possible using one or the other alone.

Various aspects of the application will be described with respect to the figures below.

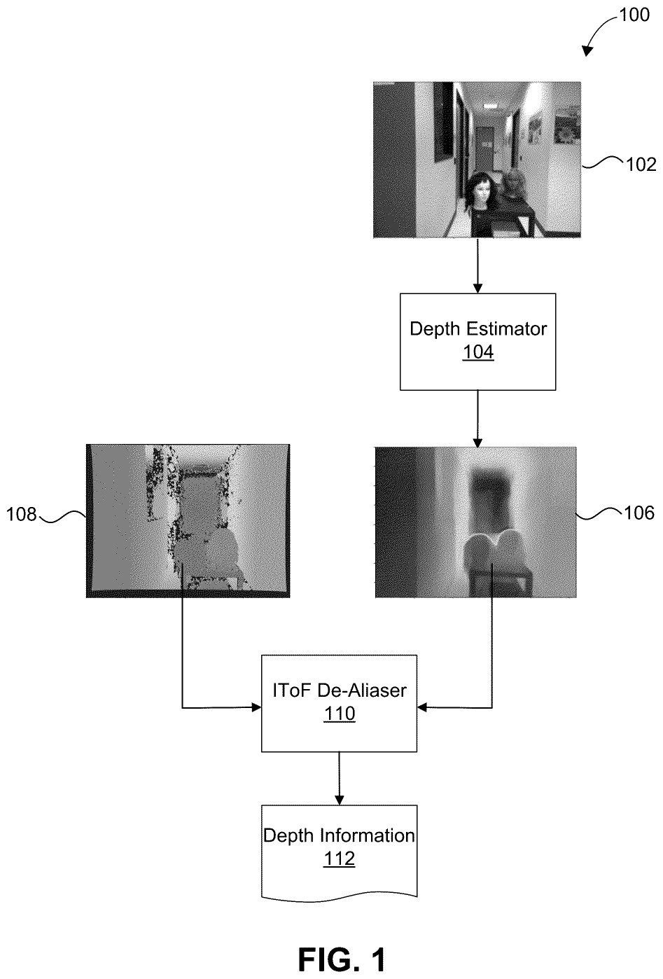

FIG. 1 is a block diagram illustrating a system 100 for de-aliasing indirect time-of-flight (iToF) depth measurements, according to various aspects of the present disclosure. System 100 may include iToF de-aliaser 110. System 100 may provide iToF depth information 108 and image-based depth information 106 to iToF de-aliaser 110. ITOF de-aliaser 110 may use image-based depth information 106 to adjust iToF depth information 108 to de-alias iToF depth information 108 to generate depth information 112.

In some cases, system 100 may obtain an image 102 of an environment captured using an image sensor. Image 102 may be formatted according to any suitable format, such as, red, green, blue (RGB), luma or brightness, blue projection, and red projection (YUV), or grayscale.

In some cases, system 100 may include a depth estimator 104 to generate image-based depth information 106 based on image 102. Depth estimator 104 may generate image-based depth information 106 using one or more image-based depth-estimation techniques, such as, for example, a monocular-depth-estimation technique or a stereoscopic-depth-estimation technique. In cases where depth estimator 104 determines image-based depth information 106 based on a stereoscopic-depth-estimation technique, image 102 may include two or more stereoscopically paired images.

In cases in which system 100 includes depth estimator 104, depth estimator 104 may provide image-based depth information 106 to iToF de-aliaser 110. In other cases, system 100 may not include depth estimator 104. In these other cases, system 100 may obtain image-based depth information 106 and provide image-based depth information 106 to iToF de-aliaser 110.

Image-based depth information 106 may be, or may include, depth information of the environment of image 102. Image-based depth information 106 may include a depth for each of a number of points of the environment. According to some aspects, image-based depth information 106 may include a depth for each pixel of image 102.

IToF depth information 108 may be, or may include, depth information of the environment of image 102 and/or image-based depth information 106. ITOF depth information 108 may include a depth for each of a number of points of the environment. ITOF depth information 108 may be determined by an iToF depth camera. The number of points of iToF depth information 108 may, or may not, be the same as the number of points of image-based depth information 106 (e.g., based on differences in resolution and/or position of a camera which captured image 102 and the iToF depth camera).

IToF de-aliaser 110 may compare iToF depth information 108 to image-based depth information 106 to determine inconsistencies between iToF depth information 108 and image-based depth information 106. For example, iToF de-aliaser 110 may relate points of iToF depth information 108 to points of image-based depth information 106 and compare orders of depths of the related points between iToF depth information 108 and image-based depth information 106. Based on the comparison, iToF depth information 108 may determine inconsistencies between the order of depths of iToF depth information 108 and the order of depths of image-based depth information 106. ITOF de-aliaser 110 may adjust depths of iToF depth information 108 based on the determined inconsistencies. For example, iToF de-aliaser 110 may adjust depths of points of iToF depth information 108 that have inconsistent orders of depths between iToF depth information 108 and image-based depth information 106. ITOF depth information 108 may adjust the depths by adding, or subtracting, an integer number of half wavelengths to the depths because the inconsistencies may be the result of multicycle aliasing of the iToF depth measurements.

Depth information 112 may be, or may include, iToF depth information 108 including adjusted depths.

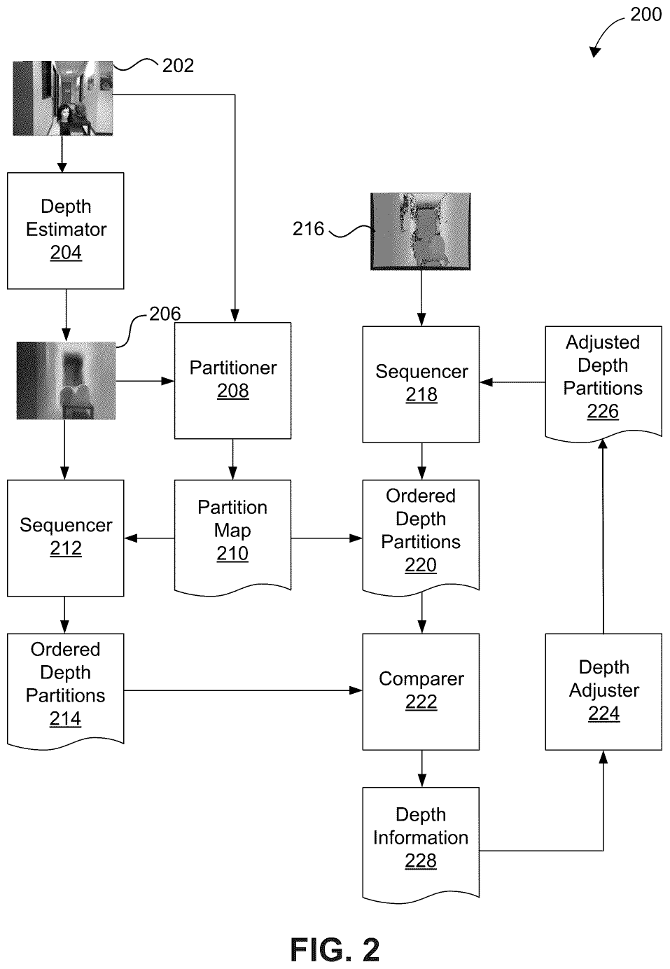

FIG. 2 is a block diagram illustrating a system 200 for de-aliasing iToF depth measurements, according to various aspects of the present disclosure. System 200 may obtain iToF-based depth information 216 and image-based depth information 206 and use image-based depth information 206 to adjust iToF-based depth information 216 to de-alias iToF-based depth information 216 to generate depth information 228.

Image 202 may be the same as, or substantially similar to, image 102 of FIG. 1. Depth estimator 204 may be the same as, be substantially similar to, or perform the same, or substantially the same, operations as depth estimator 104 of FIG. 1. Image-based depth information 206 may be the same as, or substantially similar to, image-based depth information 106 of FIG. 1. Like depth estimator 104 in system 100, depth estimator 204 may be optional in system 200. IToF-based depth information 216 may be the same as, or substantially similar to, iToF depth information 108 of FIG. 1. Depth information 228 may be the same as, or substantially similar to, depth information 112 of FIG. 1.

Partitioner 208 may partition image 202 and/or image-based depth information 206 into depth partitions (e.g., using an object-detection technique, a saliency-map technique, or a super-pixel technique). In the present disclosure the term “depth partition” may refer to a group of points of depth information. A depth partition may include points that have similar depths that are adjacent in an image plane (e.g., in image 202). For example, partitioner 208 may determine as a depth partition a group of adjacent pixels of image 202 that all have similar depths according to image-based depth information 206. Partitioner 208 may generate a partition map 210 defining the depth partitions within image 202 and/or image-based depth information 206.

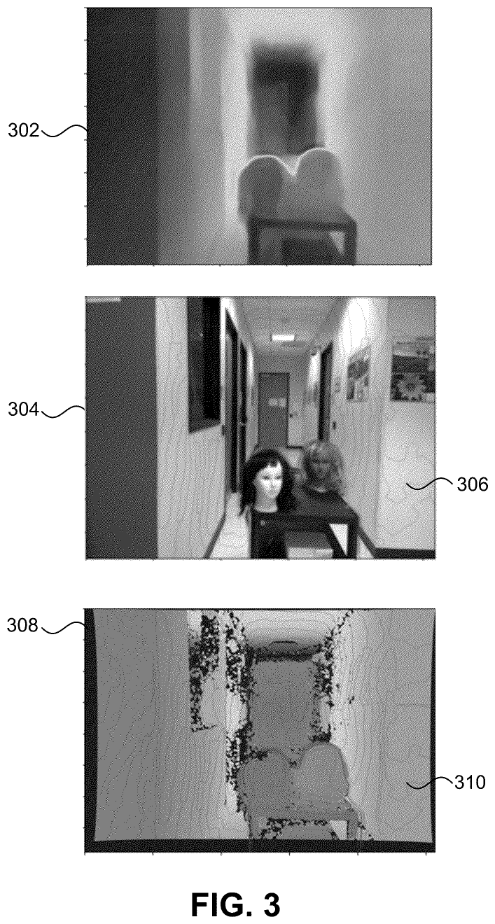

FIG. 3 includes a visual representation of example image-based depth information 302 and an example image 304 including depth partitions 306. Image 304 may be an example of image 202. Image-based depth information 302 may be an example of image-based depth information 206. Depth partitions 306 may be an example of depth partitions of partition map 210. Depths in image-based depth information 302 are represented by colors, e.g., with blue pixels representing shortest depths and red pixels representing farthest depths.

Returning to the description of FIG. 2, partitioner 208 may generate, as an example, depth partitions (e.g., depth partitions 306) that partition image 202 and/or image-based depth information 206. Each of the various depth partitions may include points that are adjacent in an image plane (e.g., in image 202) and that, based on an image-based depth-estimation technique, have a similar depth.

Sequencer 212 may order the depth partitions of image-based depth information 206 by depth to generate ordered depth partitions 214 (e.g., ordering the depth partitions of image-based depth information 206 from a shortest depth to a farthest depth). The depth of a depth partition may be defined according to a statistical measure of all the depths of all the points included in the partition. For example, the depth of a partition may be defined by an average or median of all the depths of all points included in the partition.

Sequencer 218 may apply partition map 210 to iToF-based depth information 216. For example, sequencer 218 may correlate one or more pixels of image 202 and/or one or more points of image-based depth information 206 to points of iToF-based depth information 216. Further, based on the correlations between iToF-based depth information 216 and image-based depth information 206, sequencer 218 may correlate depth partitions of partition map 210 to iToF-based depth information 216 to partition iToF-based depth information 216 into depth partitions. Sequencer 218 may order the depth partitions of iToF-based depth information 216 by depth to generate ordered depth partitions 220.

FIG. 3 includes a visual representation of example iToF-based depth information 308 partitioned by depth partitions 310. The iToF-based depth information 308 may be an example of iToF-based depth information 216. Depth partitions 310, applied to iToF-based depth information 308 may be an example of depth partitions of partition map 210 partitioning iToF-based depth information 216.

Returning to the description of FIG. 2, comparer 222 may compare ordered depth partitions 214 to ordered depth partitions 220 to determine inconsistencies between image-based depth information 206 and iToF-based depth information 216. For example, comparer 222 may determine corresponding depth partitions of image-based depth information 206 and iToF-based depth information 216 that are ordered differently (e.g., outside an order threshold) in ordered depth partitions 214 and ordered depth partitions 220. The depth partitions of image-based depth information 206 may be related (e.g., spatially) to the depth partitions of iToF-based depth information 216 through partition map 210.

As an example, of determining inconsistencies, a partition map 210 may define a rectangle-shaped depth partition near the center of image 202. Image-based depth information 206, may include a corresponding rectangle-shaped depth partition and may include a depth corresponding to the rectangle-shaped depth partition. Similarly, iToF-based depth information 216, may include a corresponding rectangle-shaped depth partition and may include a depth corresponding to the rectangle-shaped depth partition. The depth of the rectangle-shaped depth partition of image-based depth information 206 may be different from the depth of the rectangle-shaped depth partition of iToF-based depth information 216. The depths may be different because image-based depth information 206 may include scale ambiguity and/or because iToF-based depth information 216 may include errors resulting from multicycle aliasing. Thus, a direct comparison between depths of image-based depth information 206 and depths of iToF-based depth information 216 may or may not be particularly useful.

Continuing the example of determining inconsistencies, ordered depth partitions 214 may include order information indicative of a depth order of the rectangle-shaped depth partition in image-based depth information 206. For instance, according to ordered depth partitions 214, the rectangle-shaped depth partition of ordered depth partitions 214 may be among the farthest of depth partitions of image-based depth information 206. Additionally, ordered depth partitions 220 may include order information indicative of a depth order of the rectangle-shaped depth partition in iToF-based depth information 216. For instance, according to ordered depth partitions 220, the rectangle-shaped depth partition of ordered depth partitions 220 may be among the closest depth partitions of ordered depth partitions 220. Comparer 222 may determine that there is an inconsistency between image-based depth information 206 and iToF-based depth information 216 based on the difference in the depth order of the rectangle-shaped depth partition in ordered depth partitions 214 and the depth order of the rectangle-shaped depth partition in ordered depth partitions 220. Determining the inconsistencies based on ordered depth partitions 214 and ordered depth partitions 220 may be a useful means of comparing image-based depth information 206 and iToF-based depth information 216. The comparison may be useful because such a comparison may emphasize errors in iToF-based depth information 216 resulting from multicycle aliasing. Further the comparison may overcome the effects of scale ambiguity of image-based depth information 206 by not directly relying on the depths of image-based depth information 206.

Based on identified inconsistencies, depth adjuster 224 may adjust the iToF-based depth information 216, (e.g., by adding to, or subtracting from, the depths of iToF-based depth information 216) to generate adjusted depth partitions 226. Because some errors in iToF-based depth information 216 result from multicycle aliasing, the errors in iToF-based depth information 216 may cause depths of iToF-based depth information 216 to be off integer numbers of half wavelengths. Therefore, depth adjuster 224 may adjust the iToF-based depth information 216 by adding, or subtracting, integer numbers of half wavelengths to the depths of iToF-based depth information 216.

Depth information 228 may be more accurate than image-based depth information 206 because depth information 228 may include absolute depths, e.g., based on iToF-based depth information 216. Depth information 228 may be more accurate than iToF-based depth information 216 because system 200 may have de-aliased iToF-based depth information 216 to correct errors based on multicycle aliasing.

System 200 may iteratively improve depth information 228 by, after adjusting iToF-based depth information 216 to generate adjusted depth partitions 226, sequencing adjusted depth partitions 226 and comparing adjusted depth partitions 226 to ordered depth partitions 214 at comparer 222 to determine if additional inconsistencies exist between ordered adjusted depth partitions 226 and ordered depth partitions 214.

Additionally, or alternatively, according to some aspects, system 200 may merge two or more depth partitions. For example, in cases where two or more depth partitions are adjacent in the image plane and include similar depths (e.g., according to image-based depth information 206 and/or iToF-based depth information 216 (or adjusted depth partitions 226)), system 200 may merge the depth partitions.

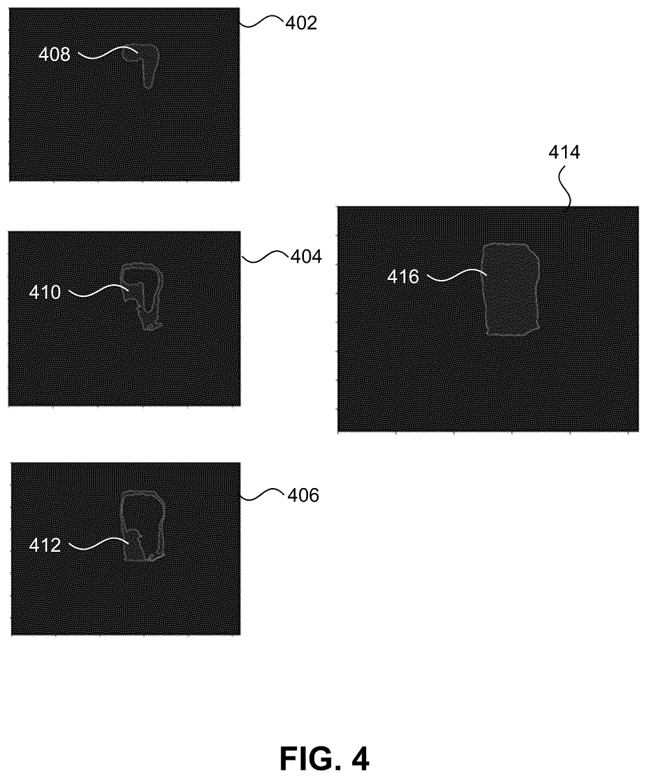

For example, FIG. 4 includes three representations (including representation 402, representation 404, and representation 406) of three respective example depth partitions (including depth partition 408, depth partition 410, and depth partition 412). Depth partition 408, depth partition 410, and depth partition 412 are adjacent to one another. Further, depth partition 408, depth partition 410, and depth partition 412 have a similar depth. Accordingly, according to some aspects, depth partition 408, depth partition 410, and depth partition 412 may be merged into depth partition 416 of a representation 414.

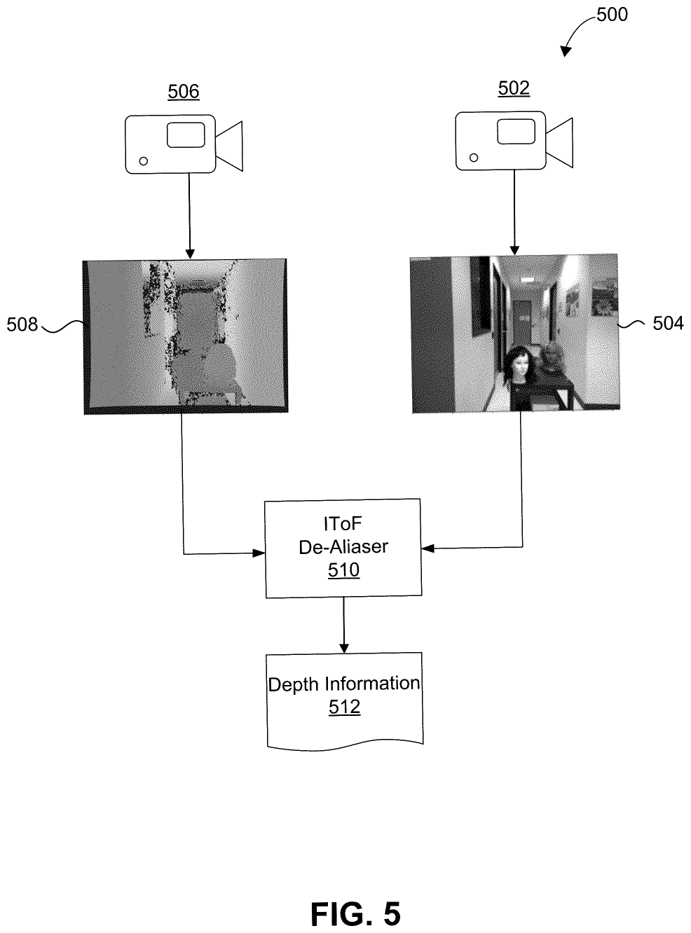

FIG. 5 is a block diagram illustrating a system 500 for de-aliasing iToF depth measurements, according to various aspects of the present disclosure.

System 500 may include a camera 502 to generate an image 504 of an environment. Image 504 may be the same as, or substantially similar to, image 102 of FIG. 1 and/or image 202 of FIG. 2.

System 500 may include an iToF depth camera 506 to generate iToF depth information 508 of the environment. IToF depth camera 506 may be positioned relative to camera 502 such that image 504 and iToF depth information 508 represent substantially the same view of the environment. IToF depth information 508 may be the same as, or substantially similar to, iToF depth information 108 of FIG. 1 and/or iToF-based depth information 216 of FIG. 2.

System 500 may include an iToF de-aliaser 510. ITOF de-aliaser 510 may be the same as, be substantially similar to, or perform the same, or substantially the same, operations as image 102 of FIG. 1 and/or system 200 of FIG. 2.

ITOF de-aliaser 510 may generate depth information 512 based on iToF depth information 508 and image 504. Depth information 512 may be the same as, or substantially similar to, depth information 112 of FIG. 1 and/or depth information 228 of FIG. 2.

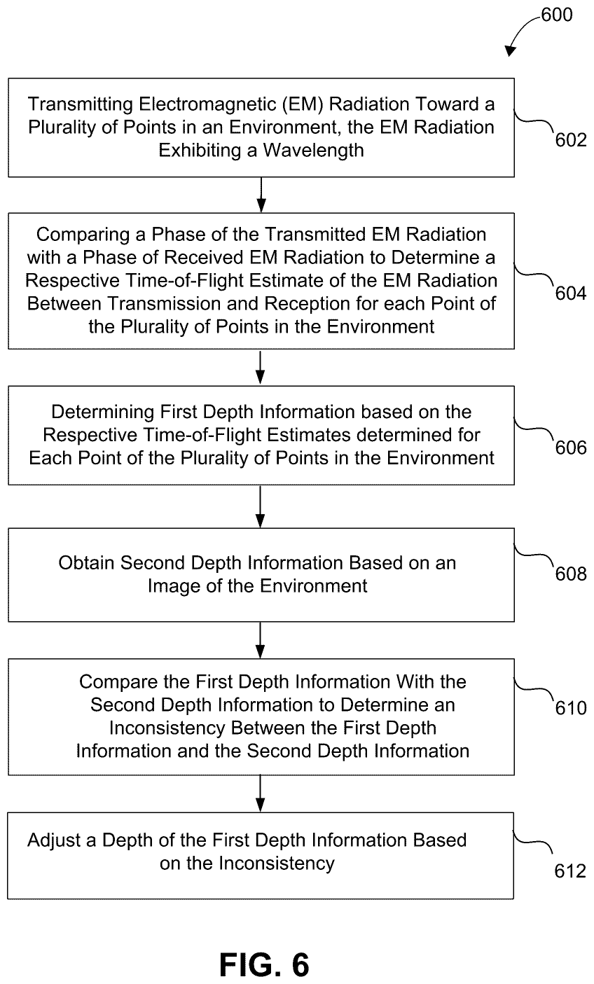

FIG. 6 is a flow diagram illustrating a process 600 for de-aliasing iToF depth measurements, in accordance with aspects of the present disclosure. One or more operations of process 600 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, a television, and/or any other computing device with the resource capabilities to perform the process 600. The one or more operations of process 600 may be implemented as software components that are executed and run on one or more processors.

At block 602, a computing device (or one or more components thereof) may transmit (or instruct or cause a transmitter to transmit) electromagnetic (EM) radiation toward a plurality of points in an environment. For example, iToF depth camera 506 of FIG. 5 may transmit EM radiation toward an environment.

At block 604, the computing device (or one or more components thereof) may compare a phase of the transmitted EM radiation with a phase of received EM radiation to determine a respective time-of-flight estimate of the EM radiation between transmission and reception for each point of the plurality of points in the environment. For example, iToF depth camera 506 may receive reflected EM radiation and compare the reflected EM radiation with the transmitted EM radiation to estimate a time-of-flight of the EM radiation.

At block 606, the computing device (or one or more components thereof) may determine first depth information based on the respective time-of-flight estimates determined for each point of the plurality of points in the environment. For example, iToF depth camera 506 may determine iToF depth information 508 based on the estimated time-of-flight information. IToF-based depth information 216 of FIG. 2 may be an example of the first depth information determined at block 606.

At block 608, the computing device (or one or more components thereof) may obtain second depth information based on an image of the environment. For example, image-based depth information 206 of FIG. 2 may be obtained. Image-based depth information 206 may be based on image 202 of FIG. 2.

In some aspects the computing device (or one or more components thereof) may obtain the image of the environment and determine the second depth information using a monocular-depth-estimation technique. For example, depth estimator 204 of FIG. 2 may obtain image 202 and may generate image-based depth information 206 based on image 202.

At block 610, the computing device (or one or more components thereof) may compare the first depth information with the second depth information to determine an inconsistency between the first depth information and the second depth information. For example, comparer 222 of FIG. 2 may compare ordered depth partitions 220 of FIG. 2 (which is depth information based on iToF-based depth information 216) with ordered depth partitions 214 of FIG. 2 (which is depth information based on image 202). Depth information 228 of FIG. 2 may be based on, or include, information regarding inconsistencies between ordered depth partitions 214 and ordered depth partitions 220.

In some aspects, the computing device (or one or more components thereof) may generate a partition map based on the image; partition the first depth information according to the partition map to generate first depth partitions; and partition the second depth information according to the partition map to generate second depth partitions. Comparing the first depth information with the second depth information (e.g., of block 610) may include comparing the first depth partitions with the second depth partitions to determine the inconsistency. For example, partitioner 208 of FIG. 2 may generate partition map 210 of FIG. 2 based on image 202. Sequencer 212 of FIG. 2 may partition image-based depth information 206 according to partition map 210 to generate ordered depth partitions 214. Sequencer 218 may partition iToF-based depth information 216 according to partition map 210 to generate ordered depth partitions 220. Comparer 222 may compare ordered depth partitions 214 with ordered depth partitions 220. In some aspects, generating the partition map may include using at least one of an object-detection technique, a saliency-map technique, or a super-pixel technique to generate the partition map based on the image. For example, partitioner 208 may use an object-detection technique, a saliency-map technique, or a super-pixel technique to generate partition map 210 based on image 202.

In some aspects, the partition map may be generated further based on the second depth information. For example, partitioner 208 may generate partition map 210 based on image 202 and on iToF-based depth information 216.

In some aspects, the computing device (or one or more components thereof) may order the first depth partitions by depth and ordering the second depth partitions by depth. Comparing the first depth partitions with the second depth partitions may include comparing the ordered first depth partitions with the ordered second depth partitions to determine the inconsistency. For example, sequencer 212 may order the depth partitions of image-based depth information 206 (as partitioned according to partition map 210) to generate ordered depth partitions 214. Sequencer 218 may order the depth partitions of iToF-based depth information 216 (as partitioned according to partition map 210) to generate ordered depth partitions 220. Comparer 222 may compare ordered depth partitions 214 with ordered depth partitions 220. In some aspects, the first depth partitions may be ordered according to a statistical measure of depths of each of the first depth partitions as indicated by the first depth information. Further, the second depth partitions may be ordered according to a statistical measure of depths of each of the second depth partitions as indicated by the second depth information.

In some aspects, the computing device (or one or more components thereof) may determine a plurality of inconsistencies based on comparing the ordered first depth partitions with the ordered second depth partitions; merge a plurality of partitions of the first depth partitions associated with the plurality of inconsistencies; and adjust a depth of the merged plurality of partitions based on the plurality of inconsistencies. For example, in comparing ordered depth partitions 214 to ordered depth partitions 220, comparer 222 may determine multiple inconsistencies. Further, comparer 222 may merge multiple partitions (e.g., depth partition 408, depth partition 410, and depth partition 412 of FIG. 4). Further, depth adjuster 224 may adjust the distances of depth information 228 (e.g., including the merged depth partitions).

At block 612, the computing device (or one or more components thereof) may adjust a depth of the first depth information based on the inconsistency. For example, depth adjuster 224 of FIG. 2 may adjust ordered depth partitions 220 based on inconsistencies determined at block 610.

In some aspects, adjusting the depth of the first depth information based on the inconsistency (e.g., at block 12) may include adjusting a depth of a depth partition of the first depth partitions. For example, comparer 222 may adjust depths of partitions of ordered depth partitions 220 based on inconsistencies between ordered depth partitions 220 and ordered depth partitions 214. In some aspects, the computing device (or one or more components thereof) may generate third depth information based on the first depth information and the adjusted depth of the depth partition. For example, comparer 222 may generate depth information 228, which may include all of the depths of ordered depth partitions 220 and one or more adjusted depths.

In some aspects, adjusting the depth of the first depth information may include adding or subtracting a distance based on the wavelength of the EM radiation to the depth of the first depth information. For example, comparer 222 may add or subtract an integer number of half wavelengths of the EM radiation transmitted at block 602 to the depth of the ordered depth partitions 220 to adjust ordered depth partitions 220.

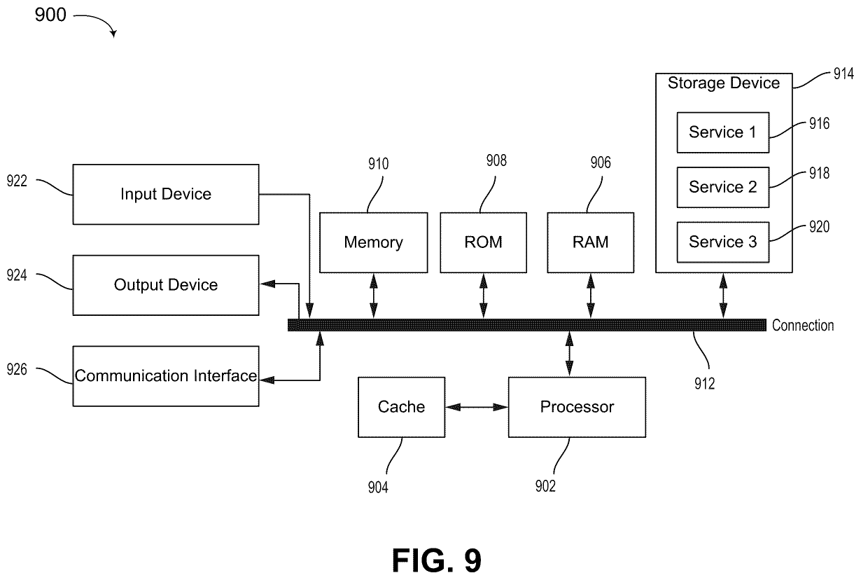

In some examples, as noted previously, the methods described herein (e.g., process 600 and/or other methods described herein) can be performed, in whole or in part, by a computing device or apparatus. In one example, one or more of the methods (e.g., process 600 and/or other methods described herein) can be performed by system 100 of FIG. 1, iToF de-aliaser 110 of FIG. 1, system 200 of FIG. 2, partitioner 208 of FIG. 2, sequencer 212 of FIG. 2, sequencer 218 of FIG. 2, comparer 222 of FIG. 2, depth adjuster 224 of FIG. 2, system 500 of FIG. 5, and/or iToF de-aliaser 510 of FIG. 5. In another example, one or more of the methods can be performed, in whole or in part, by the computing-device architecture 900 shown in FIG. 9. For instance, a computing device with the computing-device architecture 900 shown in FIG. 9 can include the components of the system 100 of FIG. 1, iToF de-aliaser 110 of FIG. 1, system 200 of FIG. 2, partitioner 208 of FIG. 2, sequencer 212 of FIG. 2, sequencer 218 of FIG. 2, comparer 222 of FIG. 2, depth adjuster 224 of FIG. 2, system 500 of FIG. 5, and/or iToF de-aliaser 510 of FIG. 5 and can implement the operations of the process 600 of FIG. 6, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 600 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine learning models or systems.

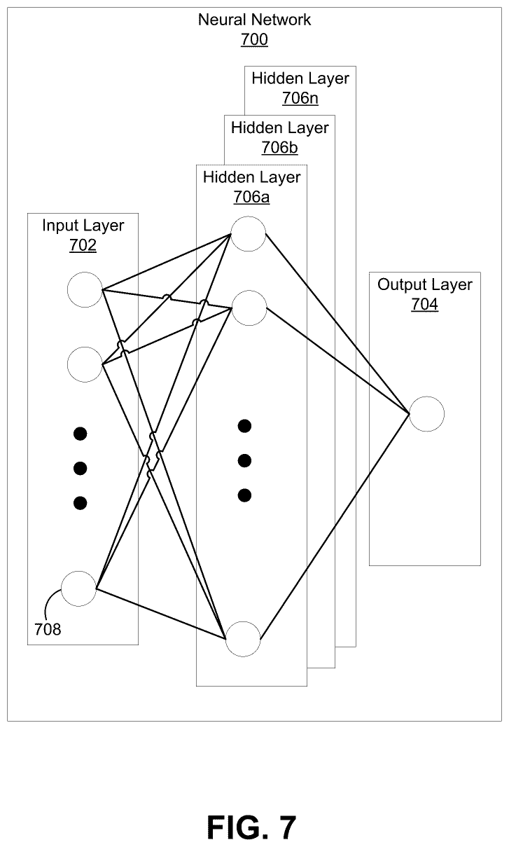

FIG. 7 is an illustrative example of a neural network 700 (e.g., a deep-learning neural network) that can be used to implement the machine-learning based partitioning, image-based depth-estimation, feature segmentation, implicit-neural-representation generation, rendering, and/or classification described above.

An input layer 702 includes input data. In one illustrative example, input layer 702 can include data representing an image. Neural network 700 includes multiple hidden layers hidden layers 706a, 706b, through 706n. The hidden layers 706a, 706b, through hidden layer 706n include “n” number of hidden layers, where “n” is an integer greater than or equal to one. The number of hidden layers can be made to include as many layers as needed for the given application. Neural network 700 further includes an output layer 704 that provides an output resulting from the processing performed by the hidden layers 706a, 706b, through 706n. In one illustrative example, output layer 704 can provide depth information.

Neural network 700 can be, or can include, a multi-layer neural network of interconnected nodes. Each node can represent a piece of information. Information associated with the nodes is shared among the different layers and each layer retains information as information is processed. In some cases, neural network 700 can include a feed-forward network, in which case there are no feedback connections where outputs of the network are fed back into itself. In some cases, neural network 700 can include a recurrent neural network, which can have loops that allow information to be carried across nodes while reading in input.

Information can be exchanged between nodes through node-to-node interconnections between the various layers. Nodes of input layer 702 can activate a set of nodes in the first hidden layer 706a. For example, as shown, each of the input nodes of input layer 702 is connected to each of the nodes of the first hidden layer 706a. The nodes of first hidden layer 706a can transform the information of each input node by applying activation functions to the input node information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 706n can activate one or more nodes of the output layer 704, at which an output is provided. In some cases, while nodes (e.g., node 708) in neural network 700 are shown as having multiple output lines, a node has a single output and all lines shown as being output from a node represent the same output value.

In some cases, each node or interconnection between nodes can have a weight that is a set of parameters derived from the training of neural network 700. Once neural network 700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 700 to be adaptive to inputs and able to learn as more and more data is processed.

Neural network 700 may be pre-trained to process the features from the data in the input layer 702 using the different hidden layers 706a, 706b, through 706n in order to provide the output through the output layer 704. In an example in which neural network 700 is used to identify features in images, neural network 700 can be trained using training data that includes both images and labels, as described above. For instance, training images can be input into the network, with each training image having a label indicating the features in the images (for the feature segmentation machine learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 700 is trained well enough so that the weights of the layers are accurately tuned.

For the example of identifying objects in images, the forward pass can include passing a training image through neural network 700. The weights are initially randomized before neural network 700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 700 can include any other deep network other than a CNN, such as an autoencoder, a deep belief nets (DBNs), a Recurrent Neural Networks (RNNs), among others.

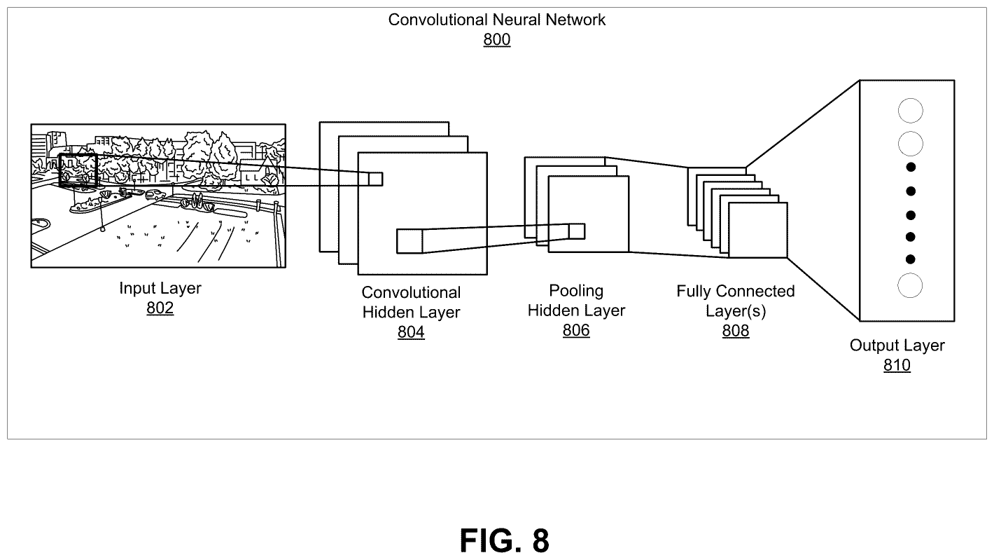

FIG. 8 is an illustrative example of a convolutional neural network (CNN) 800. The input layer 802 of the CNN 800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 804, an optional non-linear activation layer, a pooling hidden layer 806, and fully connected layer 808 (which fully connected layer 808 can be hidden) to get an output at the output layer 810. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 can be the convolutional hidden layer 804. The convolutional hidden layer 804 can analyze image data of the input layer 802. Each node of the convolutional hidden layer 804 is connected to a region of nodes (pixels) of the input image called a receptive field. The convolutional hidden layer 804 can be considered as one or more filters (each filter corresponding to a different activation or feature map), with each convolutional iteration of a filter being a node or neuron of the convolutional hidden layer 804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 804. Each connection between a node and a receptive field for that node learns a weight and, in some cases, an overall bias such that each node learns to analyze its particular local receptive field in the input image. Each node of the convolutional hidden layer 804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 804 is due to each node of the convolutional layer being applied to its corresponding receptive field. For example, a filter of the convolutional hidden layer 804 can begin in the top-left corner of the input image array and can convolve around the input image. As noted above, each convolutional iteration of the filter can be considered a node or neuron of the convolutional hidden layer 804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 804. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 804.

The mapping from the input layer to the convolutional hidden layer 804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 804 can include several activation maps in order to identify multiple features in an image. The example shown in FIG. 8 includes three activation maps. Using three activation maps, the convolutional hidden layer 804 can detect three different kinds of features, with each feature being detectable across the entire image.

In some examples, a non-linear hidden layer can be applied after the convolutional hidden layer 804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 804.

The pooling hidden layer 806 can be applied after the convolutional hidden layer 804 (and after the non-linear hidden layer when used). The pooling hidden layer 806 is used to simplify the information in the output from the convolutional hidden layer 804. For example, the pooling hidden layer 806 can take each activation map output from the convolutional hidden layer 804 and generates a condensed activation map (or feature map) using a pooling function. Max-pooling is one example of a function performed by a pooling hidden layer. Other forms of pooling functions be used by the pooling hidden layer 806, such as average pooling, L2-norm pooling, or other suitable pooling functions. A pooling function (e.g., a max-pooling filter, an L2-norm filter, or other suitable pooling filter) is applied to each activation map included in the convolutional hidden layer 804. In the example shown in FIG. 8, three pooling filters are used for the three activation maps in the convolutional hidden layer 804.

In some examples, max-pooling can be used by applying a max-pooling filter (e.g., having a size of 2×2) with a stride (e.g., equal to a dimension of the filter, such as a stride of 2) to an activation map output from the convolutional hidden layer 804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 804 having a dimension of 24×24 nodes, the output from the pooling hidden layer 806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 806 to every one of the output nodes in the output layer 810. Using the example above, the input layer includes 28×28 nodes encoding the pixel intensities of the input image, the convolutional hidden layer 804 includes 3×24×24 hidden feature nodes based on application of a 5×5 local receptive field (for the filters) to three activation maps, and the pooling hidden layer 806 includes a layer of 3×12×12 hidden feature nodes based on application of max-pooling filter to 2×2 regions across each of the three feature maps. Extending this example, the output layer 810 can include ten output nodes. In such an example, every node of the 3×12×12 pooling hidden layer 806 is connected to every node of the output layer 810.

The fully connected layer 808 can obtain the output of the previous pooling hidden layer 806 (which should represent the activation maps of high-level features) and determines the features that most correlate to a particular class. For example, the fully connected layer 808 can determine the high-level features that most strongly correlate to a particular class and can include weights (nodes) for the high-level features. A product can be computed between the weights of the fully connected layer 808 and the pooling hidden layer 806 to obtain probabilities for the different classes. For example, if the CNN 800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 810 can include an M-dimensional vector (in the prior example, M=10). M indicates the number of classes that the CNN 800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, or implement any of system 100 of FIG. 1, iToF de-aliaser 110 of FIG. 1, system 200 of FIG. 2, partitioner 208 of FIG. 2, sequencer 212 of FIG. 2, sequencer 218 of FIG. 2, comparer 222 of FIG. 2, depth adjuster 224 of FIG. 2, system 500 of FIG. 5, and/or iToF de-aliaser 510 of FIG. 5.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a reasonable degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A apparatus for determining depth information, the apparatus comprising: at least one memory; and at least one processor coupled to the at least one memory and configured to: cause at least one transmitter to transmit electromagnetic (EM) radiation toward a plurality of points in an environment; compare a phase of the transmitted EM radiation with a phase of received EM radiation to determine a respective time-of-flight estimate of the EM radiation between transmission and reception for each point of the plurality of points in the environment; determine first depth information based on the respective time-of-flight estimates determined for each point of the plurality of points in the environment; obtain second depth information based on an image of the environment; compare the first depth information with the second depth information to determine an inconsistency between the first depth information and the second depth information; and adjust a depth of the first depth information based on the inconsistency. In some cases, the apparatus includes the at least one transmitter configured to transmit the EM radiation toward a plurality of points in an environment

Aspect 2. The apparatus of aspect 1, wherein the at least one processor is further configured to: obtain the image of the environment; and determine the second depth information using a monocular-depth-estimation technique.

Aspect 3. The apparatus of any one of aspects 1 or 2, wherein the at least one processor is further configured to: generate a partition map based on the image; partition the first depth information according to the partition map to generate first depth partitions; and partition the second depth information according to the partition map to generate second depth partitions; wherein to compare the first depth information with the second depth information the at least one processor is further configured to compare the first depth partitions with the second depth partitions to determine the inconsistency.

Aspect 4. The apparatus of aspect 3, wherein to generate the partition map the at least one processor is further configured to use at least one of an object-detection technique, a saliency-map technique, or a super-pixel technique to generate the partition map based on the image.

Aspect 5. The apparatus of any one of aspects 3 or 4, wherein the at least one processor is further configured to: order the first depth partitions by depth; and order the second depth partitions by depth; wherein to compare the first depth partitions with the second depth partitions the at least one processor is further configured to compare the ordered first depth partitions with the ordered second depth partitions to determine the inconsistency.

Aspect 6. The apparatus of aspect 5, wherein the first depth partitions are ordered according to a statistical measure of depths of each of the first depth partitions as indicated by the first depth information.

Aspect 7. The apparatus of any one of aspects 5 or 6, wherein the at least one processor is further configured to: determine a plurality of inconsistencies based on comparing the ordered first depth partitions with the ordered second depth partitions; merge a plurality of partitions of the first depth partitions associated with the plurality of inconsistencies; and adjust a depth of the merged plurality of partitions based on the plurality of inconsistencies.

Aspect 8. The apparatus of any one of aspects 3 to 7, wherein to adjust the depth of the first depth information based on the inconsistency the at least one processor is further configured to adjust a depth of a depth partition of the first depth partitions.

Aspect 9. The apparatus of aspect 8, wherein the at least one processor is further configured to generate third depth information based on the first depth information and the adjusted depth of the depth partition.

Aspect 10. The apparatus of any one of aspects 3 to 9, wherein the partition map is generated further based on the second depth information.

Aspect 11. The apparatus of any one of aspects 1 to 10, wherein to adjust the depth of the first depth information the at least one processor is further configured to add or subtract a distance based on a wavelength of the EM radiation to the depth of the first depth information.

Aspect 12. The apparatus of any one of aspects 1 to 11, wherein the at least one processor is further configured to generate third depth information based on the first depth information including the adjusted depth of the first depth information.

Aspect 13. A method for determining depth information, the method comprising: transmitting electromagnetic (EM) radiation toward a plurality of points in an environment; comparing a phase of the transmitted EM radiation with a phase of received EM radiation to determine a respective time-of-flight estimate of the EM radiation between transmission and reception for each point of the plurality of points in the environment; determining first depth information based on the respective time-of-flight estimates determined for each point of the plurality of points in the environment; obtaining second depth information based on an image of the environment; comparing the first depth information with the second depth information to determine an inconsistency between the first depth information and the second depth information; and adjusting a depth of the first depth information based on the inconsistency.

Aspect 14. The method of aspect 13, further comprising: obtaining the image of the environment; and determining the second depth information using a monocular-depth-estimation technique.

Aspect 15. The method of any one of aspects 13 or 14, further comprising: generating a partition map based on the image; partitioning the first depth information according to the partition map to generate first depth partitions; and partitioning the second depth information according to the partition map to generate second depth partitions; wherein comparing the first depth information with the second depth information comprises comparing the first depth partitions with the second depth partitions to determine the inconsistency.

Aspect 16. The method of aspect 15, wherein generating the partition map comprises using at least one of an object-detection technique, a saliency-map technique, or a super-pixel technique to generate the partition map based on the image.

Aspect 17. The method of any one of aspects 15 or 16, further comprising: ordering the first depth partitions by depth; and ordering the second depth partitions by depth; wherein comparing the first depth partitions with the second depth partitions comprises comparing the ordered first depth partitions with the ordered second depth partitions to determine the inconsistency.

Aspect 18. The method of aspect 17, wherein the first depth partitions are ordered according to a statistical measure of depths of each of the first depth partitions as indicated by the first depth information.

Aspect 19. The method of any one of aspects 17 or 18, further comprising: determining a plurality of inconsistencies based on comparing the ordered first depth partitions with the ordered second depth partitions; merging a plurality of partitions of the first depth partitions associated with the plurality of inconsistencies; and adjusting a depth of the merged plurality of partitions based on the plurality of inconsistencies.

Aspect 20. The method of any one of aspects 15 to 19, wherein adjusting the depth of the first depth information based on the inconsistency comprises adjusting a depth of a depth partition of the first depth partitions.

Aspect 21. The method of aspect 20, further comprising generating third depth information based on the first depth information and the adjusted depth of the depth partition.

Aspect 22. The method of any one of aspects 15 to 21, wherein the partition map is generated further based on the second depth information.

Aspect 23. The method of any one of aspects 13 to 22, wherein adjusting the depth of the first depth information comprises adding or subtracting a distance based on a wavelength of the EM radiation to the depth of the first depth information.

Aspect 24. The method of any one of aspects 13 to 23, further comprising generating third depth information based on the first depth information including the adjusted depth of the first depth information.

Aspect 25. The method of any one of aspects 15 to 24, wherein determining the inconsistency comprises identifying a first depth partition that is outside of an order threshold in the ordered first depth partitions from a corresponding second depth partition in the ordered second depth partitions.

Aspect 26. The method of any one of aspects 15 to 25, further comprising: based on adjusting the depth of the depth partition, reordering the first depth partitions by depth; comparing the reordered first depth partitions with the ordered second depth partitions to determine a second inconsistency; and adjusting a depth of a second depth partition of the first depth partitions based on the second inconsistency.

Aspect 27. The apparatus of any one of aspects 3 to 12, wherein, to determine the inconsistency, the at least one processor is further configured to identify a first depth partition that is outside of an order threshold in the ordered first depth partitions from a corresponding second depth partition in the ordered second depth partitions.

Aspect 28. The apparatus of any one of aspects 2 to 12 or 27, wherein the at least one processor is further configured to: based on adjusting the depth of the depth partition, reorder the first depth partitions by depth; compare the reordered first depth partitions with the ordered second depth partitions to determine a second inconsistency; and adjust a depth of a second depth partition of the first depth partitions based on the second inconsistency.

Aspect 29. A method for determining depth information, the method comprising: obtaining first depth information of an environment using an indirect-time-of-flight depth-estimation technique; obtaining an image of the environment; generating second depth information based on the image; generating a partition map based on the image; partitioning the first depth information according to the partition map to generate first depth partitions; partitioning the second depth information according to the partition map to generate second depth partitions; ordering the first depth partitions by depth; ordering the second depth partitions by depth; comparing the ordered first depth partitions with the ordered second depth partitions to determine an inconsistency between the first depth information and the second depth information; and adjusting a depth of a depth partition of the first depth partitions based on the inconsistency.

Aspect 30. An apparatus for determining depth information, the apparatus comprising: at least one memory; and at least one processor coupled to the at least one memory and configured to: obtain first depth information of an environment using an indirect-time-of-flight depth-estimation technique; obtain an image of the environment; generating second depth information based on the image; generate a partition map based on the image; partition the first depth information according to the partition map to generate first depth partitions; partition the second depth information according to the partition map to generate second depth partitions; order the first depth partitions by depth; order the second depth partitions by depth; compare the ordered first depth partitions with the ordered second depth partitions to determine an inconsistency between the first depth information and the second depth information; and adjust a depth of a depth partition of the first depth partitions based on the inconsistency.

Aspect 31. A non-transitory computer-readable storage medium having stored thereon instructions that, when executed by at least one processor, cause the at least one processor to perform operations according to any of aspects 13 to 26.

Aspect 32. An apparatus for providing virtual content for display, the apparatus comprising one or more means for perform operations according to any of aspects 13 to 26.

What is claimed is:

1. A apparatus for determining depth information, the apparatus comprising:
at least one memory; and
at least one processor coupled to the at least one memory and configured to:
cause at least one transmitter to transmit electromagnetic (EM) radiation toward a plurality of points in an environment;
compare a phase of the transmitted EM radiation with a phase of received EM radiation to determine a respective time-of-flight estimate of the EM radiation between transmission and reception for each point of the plurality of points in the environment;
determine first depth information based on the respective time-of-flight estimates determined for each point of the plurality of points in the environment;
obtain second depth information based on an image of the environment;
compare the first depth information with the second depth information to determine an inconsistency between the first depth information and the second depth information; and
adjust a depth of the first depth information based on the inconsistency.

2. The apparatus of claim 1, wherein the at least one processor is further configured to:
obtain the image of the environment; and
determine the second depth information using a monocular-depth-estimation technique.

3. The apparatus of claim 1, wherein the at least one processor is further configured to:
generate a partition map based on the image;
partition the first depth information according to the partition map to generate first depth partitions; and
partition the second depth information according to the partition map to generate second depth partitions;
wherein to compare the first depth information with the second depth information the at least one processor is further configured to compare the first depth partitions with the second depth partitions to determine the inconsistency.

4. The apparatus of claim 3, wherein to generate the partition map the at least one processor is further configured to use at least one of an object-detection technique, a saliency-map technique, or a super-pixel technique to generate the partition map based on the image.

5. The apparatus of claim 3, wherein the at least one processor is further configured to:
order the first depth partitions by depth; and
order the second depth partitions by depth;
wherein to compare the first depth partitions with the second depth partitions the at least one processor is further configured to compare the ordered first depth partitions with the ordered second depth partitions to determine the inconsistency.

6. The apparatus of claim 5, wherein the first depth partitions are ordered according to a statistical measure of depths of each of the first depth partitions as indicated by the first depth information.

7. The apparatus of claim 5, wherein the at least one processor is further configured to:
determine a plurality of inconsistencies based on comparing the ordered first depth partitions with the ordered second depth partitions;
merge a plurality of partitions of the first depth partitions associated with the plurality of inconsistencies; and
adjust a depth of the merged plurality of partitions based on the plurality of inconsistencies.

8. The apparatus of claim 3, wherein to adjust the depth of the first depth information based on the inconsistency the at least one processor is further configured to adjust a depth of a depth partition of the first depth partitions.

9. The apparatus of claim 8, wherein the at least one processor is further configured to generate third depth information based on the first depth information and the adjusted depth of the depth partition.

10. The apparatus of claim 3, wherein the partition map is generated further based on the second depth information.

11. The apparatus of claim 1, wherein to adjust the depth of the first depth information the at least one processor is further configured to add or subtract a distance based on a wavelength of the EM radiation to the depth of the first depth information.

12. The apparatus of claim 1, wherein the at least one processor is further configured to generate third depth information based on the first depth information including the adjusted depth of the first depth information.

13. The apparatus of claim 1, further comprising the at least one transmitter, the at least one transmitter configured to transmit electromagnetic (EM) radiation toward a plurality of points in an environment.

14. A method for determining depth information, the method comprising:
transmitting electromagnetic (EM) radiation toward a plurality of points in an environment;
comparing a phase of the transmitted EM radiation with a phase of received EM radiation to determine a respective time-of-flight estimate of the EM radiation between transmission and reception for each point of the plurality of points in the environment;
determining first depth information based on the respective time-of-flight estimates determined for each point of the plurality of points in the environment;
obtaining second depth information based on an image of the environment;
comparing the first depth information with the second depth information to determine an inconsistency between the first depth information and the second depth information; and
adjusting a depth of the first depth information based on the inconsistency.

15. The method of claim 14, further comprising:
obtaining the image of the environment; and
determining the second depth information using a monocular-depth-estimation technique.

16. The method of claim 14, further comprising:
generating a partition map based on the image;
partitioning the first depth information according to the partition map to generate first depth partitions; and
partitioning the second depth information according to the partition map to generate second depth partitions;
wherein comparing the first depth information with the second depth information comprises comparing the first depth partitions with the second depth partitions to determine the inconsistency.

17. The method of claim 16, wherein generating the partition map comprises using at least one of an object-detection technique, a saliency-map technique, or a super-pixel technique to generate the partition map based on the image.

18. The method of claim 16, further comprising:
ordering the first depth partitions by depth; and
ordering the second depth partitions by depth;
wherein comparing the first depth partitions with the second depth partitions comprises comparing the ordered first depth partitions with the ordered second depth partitions to determine the inconsistency.

19. The method of claim 18, wherein the first depth partitions are ordered according to a statistical measure of depths of each of the first depth partitions as indicated by the first depth information.

20. The method of claim 18, further comprising:
determining a plurality of inconsistencies based on comparing the ordered first depth partitions with the ordered second depth partitions;
merging a plurality of partitions of the first depth partitions associated with the plurality of inconsistencies; and
adjusting a depth of the merged plurality of partitions based on the plurality of inconsistencies.

21. The method of claim 16, wherein adjusting the depth of the first depth information based on the inconsistency comprises adjusting a depth of a depth partition of the first depth partitions.

22. The method of claim 21, further comprising generating third depth information based on the first depth information and the adjusted depth of the depth partition.

23. The method of claim 16, wherein the partition map is generated further based on the second depth information.

24. The method of claim 14, wherein adjusting the depth of the first depth information comprises adding or subtracting a distance based on a wavelength of the EM radiation to the depth of the first depth information.

25. The method of claim 14, further comprising generating third depth information based on the first depth information including the adjusted depth of the first depth information.

26. A non-transitory computer-readable storage medium having stored thereon instructions that, when executed by at least one processor, cause the at least one processor to:
instruct at least one transmitter to transmit electromagnetic (EM) radiation toward a plurality of points in an environment;
compare a phase of the transmitted EM radiation with a phase of received EM radiation to determine a respective time-of-flight estimate of the EM radiation between transmission and reception for each point of the plurality of points in the environment;
determine first depth information based on the respective time-of-flight estimates determined for each point of the plurality of points in the environment;
obtain second depth information based on an image of the environment;
compare the first depth information with the second depth information to determine an inconsistency between the first depth information and the second depth information; and
adjust a depth of the first depth information based on the inconsistency.

27. The non-transitory computer-readable storage medium of claim 26, wherein the instructions, when executed by the at least one processor, cause the at least one processor to:
obtain the image of the environment; and
determine the second depth information using a monocular-depth-estimation technique.

28. The non-transitory computer-readable storage medium of claim 26, wherein the instructions, when executed by the at least one processor, cause the at least one processor to:
generate a partition map based on the image;
partition the first depth information according to the partition map to generate first depth partitions; and
partition the second depth information according to the partition map to generate second depth partitions;
wherein to compare the first depth information with the second depth information the instructions, when executed by the at least one processor, cause the at least one processor to compare the first depth partitions with the second depth partitions to determine the inconsistency.

29. The non-transitory computer-readable storage medium of claim 28, wherein to generate the partition map the instructions, when executed by the at least one processor, cause the at least one processor to use at least one of an object-detection technique, a saliency-map technique, or a super-pixel technique to generate the partition map based on the image.

30. The non-transitory computer-readable storage medium of claim 28, wherein the instructions, when executed by the at least one processor, cause the at least one processor to:
order the first depth partitions by depth; and
order the second depth partitions by depth;
wherein to compare the first depth partitions with the second depth partitions the instructions, when executed by the at least one processor, cause the at least one processor to compare the ordered first depth partitions with the ordered second depth partitions to determine the inconsistency.
